(19) United States
(12) Patent Application Publication
(10) Pub. No.: US 2011/0022890 A1
(43) Pub. Date: Jan. 27, 2011

(54) CLOCK AND DATA RECOVERY CIRCUIT WITH ELIMINATING DATA-DEPENDENT JITTERS

(75) Inventors: Deog Kyoon Jeong, Seoul (KR); Jin-Hee Lee, Seoul (KR)

Correspondence Address: Vedder Price P.C., 875 15th Street NW, Suite 725, Washington, DC, 20005, US

(73) Assignee: SNU Industry Foundation, Seoul (KR)

(21) Appl. No.: 12/933,956

(22) PCT Filed: Apr. 4, 2008
(86) PCT No.: PCT/KR2008/001897

§ 371 Date: Sep. 22, 2010

(51) Int. Cl. G06F 11/14

(52) U.S. Cl. 714/15; 714/E11.117

(57) ABSTRACT

The present invention relates to a clock and data recovery circuit (CDR), and in particular, to a CDR circuit in a full digital scheme which cancels the data-dependent jitter. A DDJ cancellation circuit according to the present invention efficiently cancels the data-dependent jitter, making it possible to configure the reliable clock and data recovery circuit in the serial link data communication through the channel of the predetermined bandwidth.

### TECHNICAL FIELD

The present invention relates to a clock and data recovery circuit with eliminating a data-dependent jitter in serial link communication (hereinafter, referred to as “CDR circuit”), and in particular, to a technology of canceling a data-dependent jitter in a CDR circuit implemented by a full digital circuit.

### BACKGROUND ART

A currently-employed serial link tranceiver technology does not separately transmit a clock signal to a receiving end but transmits only data stream thereto through a communication channel, wherein the receiving end recovers a clock and a data sequence from the received data stream. Therefore, it is necessary to prepare a CDR circuit for extracting a clock and data information from the transmitted serial data sequence in order to process the serial data stream of several giga bits to several tens giga bits per second.

The CDR circuit according to the prior art is configured to include a phase detector, a frequency detector, a voltage control oscillator (VCO), and a loop filter.

The operation of the CDR circuit is based on a principle that the phase detector extracts data values and edge values by sampling the serial data bit stream with a clock, which is provided from the voltage control oscillator, and thereby detects the phase of the sampled data for the determination if the detected phase is lagged or led so that the loop filter raises or lowers the feedback voltage which is supplied to the voltage control oscillator. Consequently, it is possible to fine-control the recovery clock which is produced by the voltage control oscillator.

The prior art which implements the clock and data recovery with an analog circuit is disclosed in detail in KR Laid-Open Patent No. 10-2004-75243. Further, the related art that partially implements the foregoing analog CDR circuit with a digital circuit is found in an article disclosed in IEEE Journal of Solid-State Circuits Volume 32, No. 11, pp. 1683-1692, published in November, 1997. However, as the integration density of a semiconductor integrated circuit increases and the design rule thereof reduces down to several tens nanometer or less, a need to implement the entire CDR circuit with a full digital circuit is being increased.

FIG. 1 is a schematic block diagram illustrating a CDR circuit implemented with a digital circuit scheme according to the related art. Referring to FIG. 1, the CDR circuit is configured to include a data retimer 10 which samples the input serial data, a time-to-digital converter 20 for phase detection, a loop filter, and a digital controlled oscillator 40.

Herein, the loop filter 30 is a digital block which implements an analog loop filter circuit of resistor, and capacitors in the prior art analog circuit with adders and multipliers. The digital controlled oscillator 40 (DCO) is a block which digitalizes the existing analog voltage controlled oscillator (VCO). Further, the TDC circuit 20 is a circuit that detects the phase of the sampled date with the current clock.

However, it is difficult to accurately recover a clock because a phase error including the jitter is fed into phase information applied to the loop filter 30 in the case of a digital CDR circuit according to the prior art, due to the data-dependent jitter (hereinafter, referred to as “DDJ”) occurring by inter-symbol interference (hereinafter, referred to as “ISI”) in a channel due to a limited channel bandwidth.

In order to overcome the problem due to the limited channel bandwidth, channel equalization technologies have been widely used in the art. The channel equalization technologies, such as time-continuous equalization technology, a decision feedback equalization technology, etc., tend to expand a vertical axis of a data eye but do not expand a width of a horizontal time axis, which still has the problem of the timing jitter even though the channel equalization technology is applied.

In order to overcome the problem of the data-dependent jitter (DDJ) due to the channel ISI, an edge equalization technology was proposed in IEEE Journal of Solid-State Circuit, Volume 41, Section 3, pp. 607-620, published in March, 2006. The technology proposed by J. F. Buckwalter has a constrained adaptation policy under specific conditions, which has a limitation for applying the edge equalization technology to any channels whose characteristics are not known.

### DISCLOSURE OF INVENTION

### Technical Problem

Therefore, it is an object of the present invention to provide a method and architecture for solving a data-jitter dependent problem in implementing the entire clock and data recovery device with a digital circuit.

### Technical Solution

The present invention is characterized in that an adaptive DDJ canceller is prepared at the front end of a loop filter for the cancellation of a data-dependent jitter (DDJ) in a loop for clock recovery. As a consequence, the present invention can cancel the DDJ from digital signals output from a TDC circuit and feed it to the loop filter.

The technology proposed by J. F. Buckwalter, which is published in the aforementioned IEEE Journal of Solid-State Circuits, March, 2006, configures a feedback architecture for edge equalization, while the present invention uses a feed-forward architecture in order to provide coefficients adapting to any channel characteristics.

### ADVANTAGEOUS EFFECTS

The feed-forward architecture according to the present invention cancels the DDJ in a discrete-time domain and mitigates the timing problem for estimating the DDJ. Therefore, the present invention uses a finite impulse response filter (hereinafter, referred to as “FIR filter”) in order to implement the adaptive DDJ cancellation circuit and uses a time-to-digital converter (TDC) for the phase detection.

### BRIEF DESCRIPTION OF DRAWINGS

FIG. 1 is a block diagram illustrating a CDR circuit implemented by a digital circuit scheme according to the prior art;

FIGS. 2 and 3 are schematic diagrams graphically illustrating the effect of the values of preceding data sequences on the crossing time of the transition edge in the current data sequence received in a serial link tranceiver scheme.

FIG. 4 is a diagram illustrating the size of a timing jitter of the received digital sequence on the horizontal axis while the frequency thereof is plotted on the vertical axis;

FIG. 5 is a diagram where a frequency histogram of a timing jitter of FIG. 4 is decomposed into two curves;

FIG. 6 is a diagram illustrating the frequency distribution of the decomposed timing jitter in consideration of the preceding two bits of data as another embodiment of the present invention;

FIG. 7 is a diagram illustrating the configuration of a clock and data recovery circuit including an adaptive DDJ cancellation block according to an exemplary embodiment of the present invention;

FIG. 8 is a diagram illustrating an N-tap DDJ cancellation circuit that implements the DDJ cancellation circuit according to an exemplary embodiment of the present invention; and

FIG. 9 is a diagram illustrating an embodiment implementing a TDC according to the present invention.

### BEST MODE FOR CARRYING OUT THE INVENTION

In a digital circuit, a timing jitter can be generally classified as two categories: a random jitter (RJ) and a deterministic jitter (DJ). In addition, the DJ can be classified as three categories: a bounded uncorrelated jitter (BUT), a data-dependent jitter (DDJ), and a periodic jitter (PJ).

The detailed description regarding the timing jitter can be found in the Proceeding of IEEE International Test Conference, pp. 1295-1302, published in 2004. As aforementioned, the DDJ is generated due to a phenomenon that the value of a preceding data sequence influences the crossing time of a current transition edge, that is, inter-symbol interference, in the received data sequence.

FIGS. 2 and 3 are a diagram graphically illustrating the effect of values of the preceding data sequences on the cross time of a current transition edge in the data sequence received in a serial link tranceiver scheme. Referring to FIG. 2, when preceding bits of data sequence are, for example, “000”, the voltage transitioned from “0” to “1” is insufficient, such that when data at a current time shown by an arrow in FIG. 2 are transitioned from “1” to “0”, they are subjected to an early edge.

Referring to FIG. 3, when the preceding data sequence is, for example, “111”, the data voltage is “1” even when the same logic is “1”, such that when data at a current time shown by an arrow in FIG. 3 are transitioned from “1” to “0”, they are subjected to a late edge.

The timing edge transition from “1” to “0” at a sampling clock depends upon the bit value of the preceding bit of data (“1” or “0”), which is referred to as DDJ.

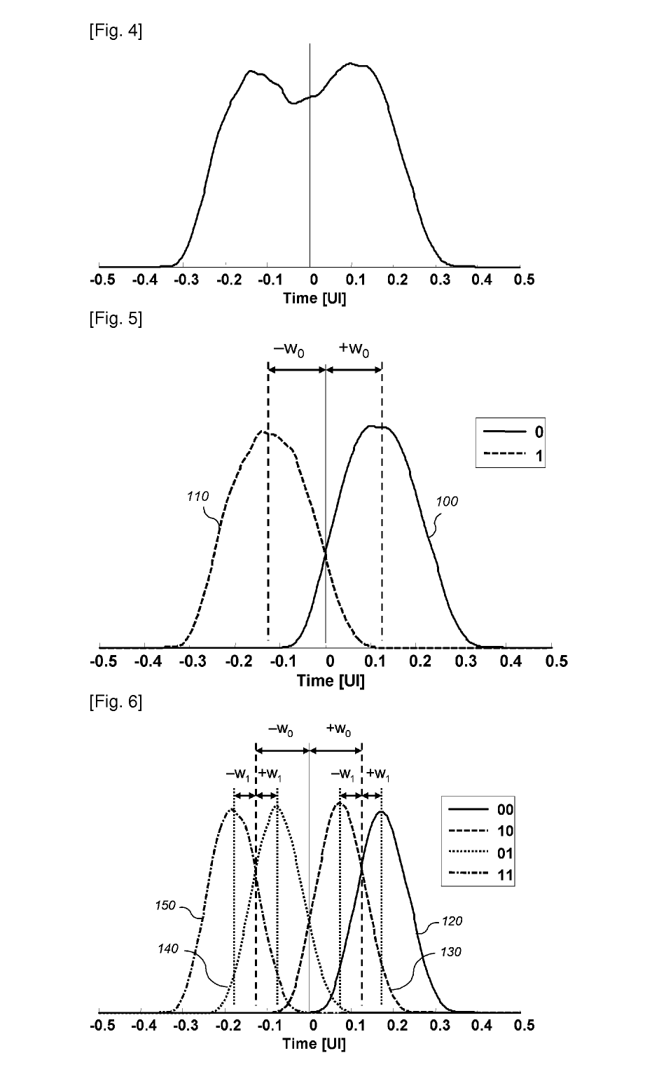

FIG. 4 is a diagram illustrating the size of the timing jitter of the received digital sequence on the horizontal axis while the frequency thereof is represented on the vertical axis. Referring to FIG. 5, the timing jitter is distributed in the range of approximately −0.4 (unit interval) to +0.4 UI, wherein the case where the timing jitter is 0 UI is an ideal state, which represents the case where the data signals are normally fed without being lagged or led.

The frequency diagram in FIG. 4 depicts the sum of two distribution curves, which can be decomposed. In other words, FIG. 5 is a diagram where the frequency histogram of the timing jitter shown in FIG. 4 is decomposed into two curves. A solid line 100 represents the frequency histogram in the case where the bit value of the preceding sequence is 0 (early edge) while a dotted line 110 represents the frequency histogram in the case where the bit value of the preceding sequence is 1 (late edge).

Referring to FIG. 5, each of the frequency distribution curves 100 and 110, which is decomposed into the sum of two curves, has the timing jitter in the range of −0.4 ˜+0.1 UI and −0.1 ˜+0.4 UI, such that when it parallel-translates based on an axis t=0 as a central axis, it can reduce the timing jitter to the range of −0.25 ˜+0.25 UI. Therefore, if we examine the decomposition process of the frequency curve of FIG. 5, we can understand that the decomposition process comprises a decomposition step and a parallel-translation step of the frequency histogram by referring to the preceding bit value, which makes it possible to reduce the DDJ.

In other words, the present invention provides an adaptive DDJ cancellation circuit which implements the algorithm wherein the frequency distribution curve of the timing jitter shown in FIGS. 4 and 5 is decomposed into the curves corresponding to the early edge and the late edge, respectively, and reduces the timing jitter Δt by parallel-translating each curve to an axis of t=0.

FIG. 6 is a diagram illustrating another embodiment of the present invention, and a diagram illustrating the frequency distribution of the timing jitter which takes into account two preceding bits of data sequence. If 2 bits are used as preceding data bits, we can expect further reduction in the DDJ than the case of 1 bit.

Referring to FIG. 6, it can be appreciated that each of four distribution curves 120, 130, 140, and 150 is formed by decomposing the frequency distribution curve of the falling transition edge timing jitter when each of the data values of preceding 2 data bits is “00”, “10”, “01”, and “11”. Referring to FIG. 5, we can see that each central axis of the two frequency distribution curves is apart from t=0 by −w₀ and +w₀. Referring to the second bit of the curves in FIG. 6, we can see that the frequency distribution curves can be decomposed into two curves which are apart from the centers of each central axis of two frequency curves by −w₁ and +w₁.

Hereinafter, the algorithm of the invention which cancels the data-dependent jitter (DDJ) will be described in detail.

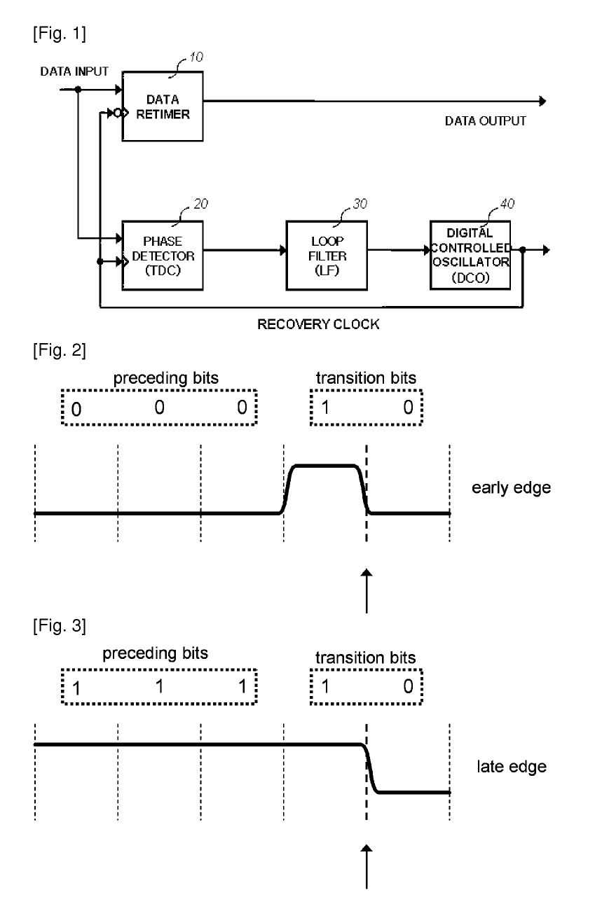

When the random digital data sequence is transmitted through the channel, the crossing time t_{c} of the received signal can be represented by a time constant τ of the channel. When α₋₁=0 α₀=1, the half-level crossing time for the rising edge is given as follows.

$$\begin{matrix}MathFigure 1 & \\ \begin{matrix}{t}_{c , rise} = τ ln [ 2 - 2 {\sum }_{n = - ∞}^{- 2} {a}_{n} ( {α}^{- n - 1} - {α}^{- n} ) ] \\ = τ ln 2 + τ ln [ 1 - ( 1 - α ) {\sum }_{n = - ∞}^{- 2} {a}_{n} {α}^{- n - 1} ]\end{matrix} & [ Math . 1 ]\end{matrix}$$

where, τ means a unit interval of a symbol, α means e^{-t/τ} and αn means n-th symbol which is transmitted earlier than the current symbol by an amount of a cycle. The logarithmic function, which is the second term of the above Math Figure 1, can be linearly approximated as the following by referring to the following Math Figure 2.

$$\begin{matrix}MathFigure 2 & \\ ln ( 1 - x ) ≅ \frac{ln ( 1 - ɛ )}{ɛ} x , ( 0 \leq x \leq ɛ ) & [ Math . 2 ]\end{matrix}$$

where, ε is a positive number smaller than ½. If the eye diagram of the received signal is opened, the value of α is 0<α<½, Math Figure 1 has a maximum value of α when all sequences prior to α₋₁ are 1 while having a minimum value of zero (0) when all sequences prior to α₋₁ are 0.

$$\begin{matrix}MathFigure 3 & \\ 0 \leq ( 1 - α ) {\sum }_{n = - ∞}^{- 2} {a}_{n} {α}^{- n - 1} \leq α & [ Math . 3 ]\end{matrix}$$

Using the above Math Figures 2 and 3, we can see that the crossing time of Math Figure 1 can be represented by the following linear function.

$$\begin{matrix}MathFigure 4 & \\ \begin{matrix}{t}_{c , rise} ≅ τ ln 2 + τ \frac{ ln ( 1 - α )}{α} ( 1 - α ) {\sum }_{n = - ∞}^{- 2} {a}_{n} {α}^{- n - 1} \\ = {t}_{c 0} + {\sum }_{n = - ∞}^{- 2} {t}_{c}^{( n )} {a}_{n}\end{matrix} & [ Math . 4 ]\end{matrix}$$

where, t_{co} represents an ideal crossing time when there is no DDJ, and t_{c}⁽ⁿ⁾ represents the transition amount of the crossing time occurring due to αₙ. Consequently, the DDJ can be calculated from the linear relationship between the transmission sequence αₙ and the crossing time t_{C} with an FIR filter.

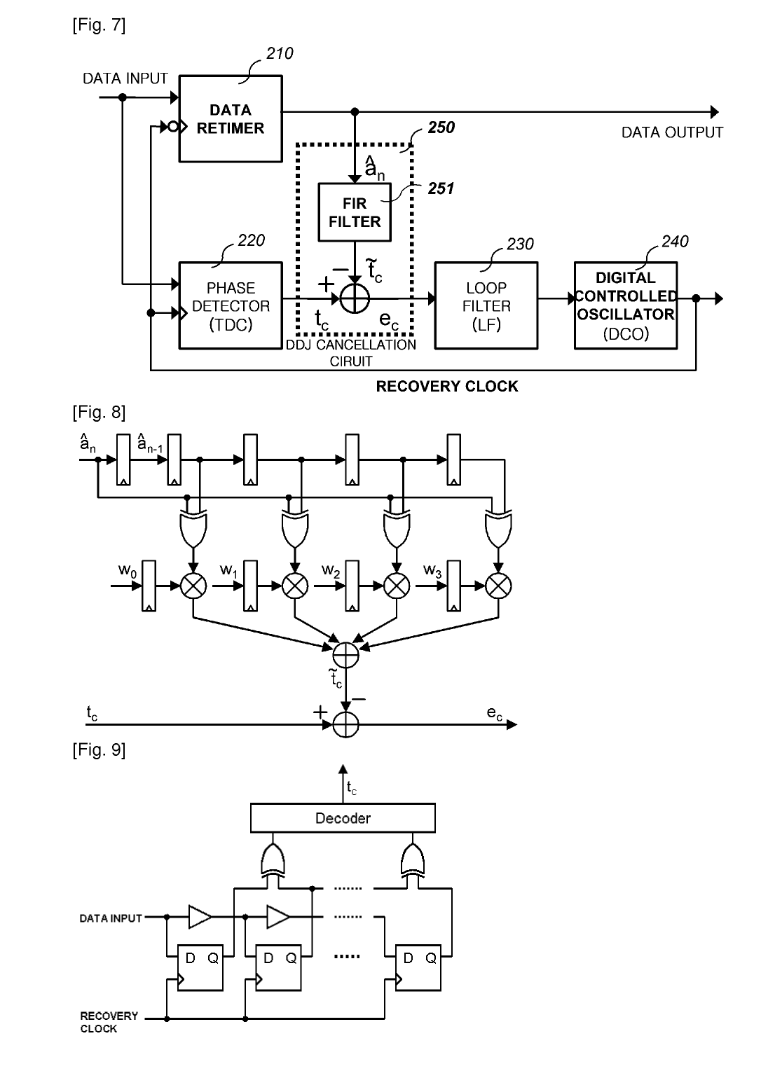

FIG. 7 is a diagram illustrating the configuration of the clock and data recovery circuit including the adaptive DDJ cancellation circuit according to an exemplary embodiment of the present invention. Referring to FIG. 7, we can conclude that the present invention uses a TDC 220 as a phase detector and uses the adaptive DDJ cancellation circuit 250 which is inserted between the phase detector 220 and the loop filter 230 as a feed-forward feedback scheme.

$$\begin{matrix}MathFigure 5 & \\ {\tilde{t}}_{c} = {\sum }_{n = - N - 1}^{- 2} {w}_{n} {\hat{a}}_{n} & [ Math . 5 ]\end{matrix}$$

Where N is the number of taps used in the DDJ cancellation circuit 250 and wₙ is a tap coefficient, and âₙ is an estimated symbol. Applying a least mean square (LMS) theory to adapt the DDJ cancellation circuit 250 of FIG. 4 to the input jitter characteristics, it approaches n-th value t_{c}⁽ⁿ⁾ of the crossing time error of the crossing coefficient wₙ.

$$\begin{matrix}MathFigure 6 & \\ {w}_{n} ≅ {t}_{c}^{( n )} = τ ( 1 - α ) {α}^{- n - 2} ln ( 1 - α ) & [ Math . 6 ]\end{matrix}$$

Herein, since the DDJ exhibits the linear dependence on the data sequence as described above, the DDJ cancellation circuit can be implemented with FIR filters as shown in FIG. 4.

The present invention employs a TDC 220 and an FIR filter 251. Since the DDJ cancellation circuit 250 according to the present invention is implemented entirely by full digital circuits, the aforementioned LMS algorithm can be easily implemented with error signals whose DDJ has been digitally cancelled. The DDJ cancellation circuit according to the present invention can be applied to any channel having its own channel characteristics.

FIG. 8 is a diagram illustrating a 4-tap DDJ cancellation circuit which implements the DDJ cancellation circuit according to an exemplary embodiment of the present invention. Referring to FIG. 8, we see that the input of the FIR filter is a retimed symbol âₙ and the output \tilde{t}_{c} thereof is the estimated DDJ through calculation. Subtracting the estimated DDJ from the detected phase error, we can obtain the phase information e_{c} whose DDJ has been cancelled and thus we can use e_{c} in the CDR loop. Therefore, the CDR circuit including the DDJ cancellation circuit in accordance with the present invention can significantly reduce the jitter and the bit error rate of the received data stream where noise has been mixed due to the channel ISI the DDJ cancellation circuit shown in FIG. 8 is operated only when the data transition occurs, which is different from the general FIR filter in the art. When the polarity of the previously detected symbol is opposite to the currently estimated symbol âₙ, it means that the sequence is transitioned. The current estimated symbol âₙ representing the edge direction inverts the symbol using an XOR gate in order to reduce the size of the hardware to a half.

MathFigure 7

w_{k,n+1}=w_{k,n}+μ·sgn(e_{c,n})·(âₙ⊕âₙ₋ₖ₋₂) [Math.7]

Where w_{k,n} is a k-th tap coefficient at a current time instant n and μ is a gain coefficient for adaptation. Since the sgn function of the Math Figure 7 has a feature of eliminating the multiplier of the coefficient update circuit, the update circuit can be implemented by a shifter and an adder. As an exemplary embodiment of the present invention, a parallel signal processing scheme can be used in order to increase the yield of the digital filter.

FIG. 9 is a diagram illustrating an embodiment implementing the TDC according to the present invention. Referring to FIG. 9, we can understand that the time-to-digital converter (TDC) calculates the phase t_{c} of the discrete value which represents the position of the edge in the detection range. When the edge is positioned at the center of the detection range, the TDC outputs zero phase error. On the other hand, the TDC outputs a positive number in the case of the early edge, while the TDC outputs a negative number in the case of the late edge.

The aformentioned somewhat widely improves the characteristics and technical advantages of the present invention so that the scope of the invention to be described later can be more clearly understood. The additional characteristics and technical advantages that constitute the scope of the present invention will be described below. The features that the disclosed concept and specific embodiments of the present invention can be instantly used as a basis designing or correcting other structure for accomplishing a similar object with the present invention should be recognized by those skilled in the art.

Further, it will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

As described above, the DDJ cancellation circuit according to the present invention efficiently cancels the data-dependent jitter, making it possible to configure the reliable clock and data recovery circuit in the serial link data communication through the channel of the predetermined bandwidth.

1. A clock and data recovery circuit (CDR) receiving a serial link data sequence, recovering a clock, extracting data, and comprising:
a data retimer which extracts the data by sampling the received data sequence with the recovered clock;
a time-to-digital converter (TDC) that receives the sampled digital data as well as the recovery clock and produces a phase error t_{c} as a discrete value by keeping track of the position of a rising edge or a falling edge;
a DDJ cancellation circuit including an N-tap FIR filter and an adder wherein the N-tap FIR filter receives the sequence symbol âₙ of the data retimer as an input and produces DDJ \tilde{t}_{c} as an output, characterized by the features that the N tap coefficients of the FIR filter are determined by
w_{k,n+1}=w_{k,n}+μ·sgn(e_{c,n})·(âₙ⊕âₙ₋ₖ₋₂)
(where, w_{k,n} is a k-th tap coefficient at a current time, μ is gain constant for adaptation, and e_{c,n} is the error between t_{c} and \tilde{t}_{c} at a current time n), the FIR filter is the one an FIR filter that sums and outputs the output DDJ from the Math Figure
$${\tilde{t}}_{c} = {\sum }_{k = - N - 1}^{- 2} {w}_{k} {\hat{a}}_{k , n}$$
, the adder being the one that calculates the difference between the output t_{c} of the TDC and the output \tilde{t}_{c} of the FIR filter;
a digital loop filter that receives the output error e_{c} of the DDJ cancellation circuit for accumulation and generates a signal for controlling digital controlled oscillator; and
the digital controlled oscillator that recovers and generates a clock under a control of the loop filter and supplies the clock to the data retimer and the TDC.
